(19) United States
(12) Patent Application Publication
(10) Pub. No.: US 2016/0299617 A1
(43) Pub. Date: Oct. 13, 2016

(54) VEHICLE PASSENGER INPUT SOURCE IDENTIFICATION

(71) Applicant: Ford Global Technologies, LLC, Dearborn, MI (US)

(72) Inventors: Ryan Edwin Hanson, Livonia, MI (US); John Robert Van Wiemeersch, Novi, MI (US); Laura Viviana Hazebrouck, Birmingham, MI (US); Ronald Patrick Brombach, Plymouth, MI (US)

(73) Assignee: Ford Global Technologies, LLC, Dearborn, MI (US)

(21) Appl. No.: 14/684,716

(22) Filed: Apr. 13, 2015

(51) Int. Cl. G06F 3/041

(52) U.S. Cl. CPC G06F 3/0416

(57) ABSTRACT

A vehicle system includes a signal generator programmed to output an occupant signal. A processing device is programmed to identify a location of at least one occupant based at least in part on whether a user input provided to a touch-sensitive display device includes the occupant signal. A method includes generating an occupant signal, transmitting the occupant signal through a vehicle occupant, receiving a user input, determining whether the user input includes the occupant signal, and identifying a location of the vehicle occupant based at least in part on whether the user input includes the occupant signal.

### BACKGROUND

Touchscreen displays are frequently incorporated into vehicle infotainment systems. Touchscreen displays often present a contextual menu, meaning that the menu of options changes based on various circumstances. For example, a radio menu may be shown when a user presses a radio button and a climate control menu may be shown when a user presses a climate control button. The availability of some touchscreen display features may be limited to particular circumstances. For example, features that require significant driver interaction, such as a search feature that requires the driver to enter a street name of point of interest in a text box using a virtual keyboard, may be unavailable while the vehicle is moving. One option is to permit the driver to use voice commands to execute features that would otherwise be prohibited while the vehicle is moving.

### BRIEF DESCRIPTION OF THE DRAWINGS

FIG. 1 illustrates an example vehicle having a system for identifying locations of users of a vehicle user interface device and making certain features available to certain vehicle occupants.

FIG. 2 illustrates the identification system of FIG. 1 incorporated into a vehicle passenger compartment.

FIG. 3 is a block diagram of the identification system of FIGS. 1 and 2.

FIG. 4 is a flowchart of an example process that may be executed by the system of FIG. 1 for making certain features available to certain occupants.

### DETAILED DESCRIPTION

Making certain infotainment system features unavailable while the vehicle is moving is often intended to keep the driver focused on operating the vehicle. Passengers, i.e., occupants who are not operating the vehicle, may still wish to use such features. Because passengers are not operating the vehicle, there is little reason to lock out features to both the passengers and the driver.

An example vehicle that makes infotainment features available to some occupants, such as the passengers but not the driver, under certain circumstances includes a user interface device, a signal generator, and a processing device. The user interface device has a touch-sensitive display screen programmed to receive a user input. The signal generator is programmed to output an occupant signal that can be transmitted with the user input when an occupant touches the user interface device. The processing device is programmed to identify a location of at least one occupant based at least in part on whether the user input includes the occupant signal. This system, therefore, can determine, from the occupant signal, whether a user input came from the driver or a passenger. Accordingly, when the vehicle is moving above a certain speed, the user interface device may only accept user inputs from passengers and reject user inputs from the driver.

The elements shown may take many different forms and include multiple and/or alternate components and facilities. The example components illustrated are not intended to be limiting. Indeed, additional or alternative components and/or implementations may be used.

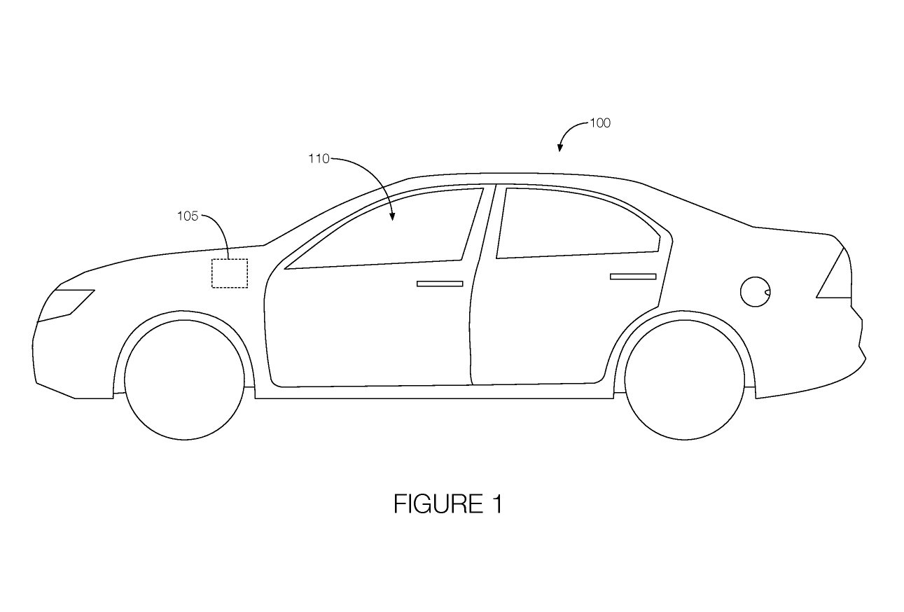

As illustrated in FIG. 1, the host vehicle 100 includes an identification system 105 for identifying the locations of vehicle occupants and for making certain infotainment system options available based on where a user input originated. When the host vehicle 100 is in use, the occupants may be seated in the passenger compartment 110 of the host vehicle 100. In general, the occupants may be characterized as a driver or passenger. The driver may be the occupant sitting in the driver seat. The passengers may be any occupants sitting in seats other than the driver seat. As discussed in greater detail below, the identification system 105 may determine whether a user input was originated by the driver or a passenger and either accept or reject the user input accordingly. Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle configured to operate in an autonomous (e.g., driverless) mode, a partially autonomous mode, and/or a non-autonomous mode.

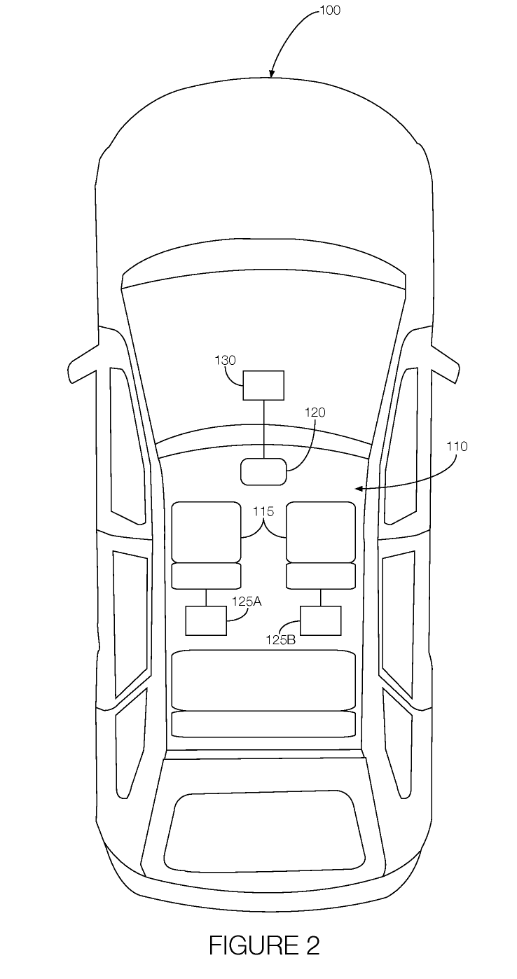

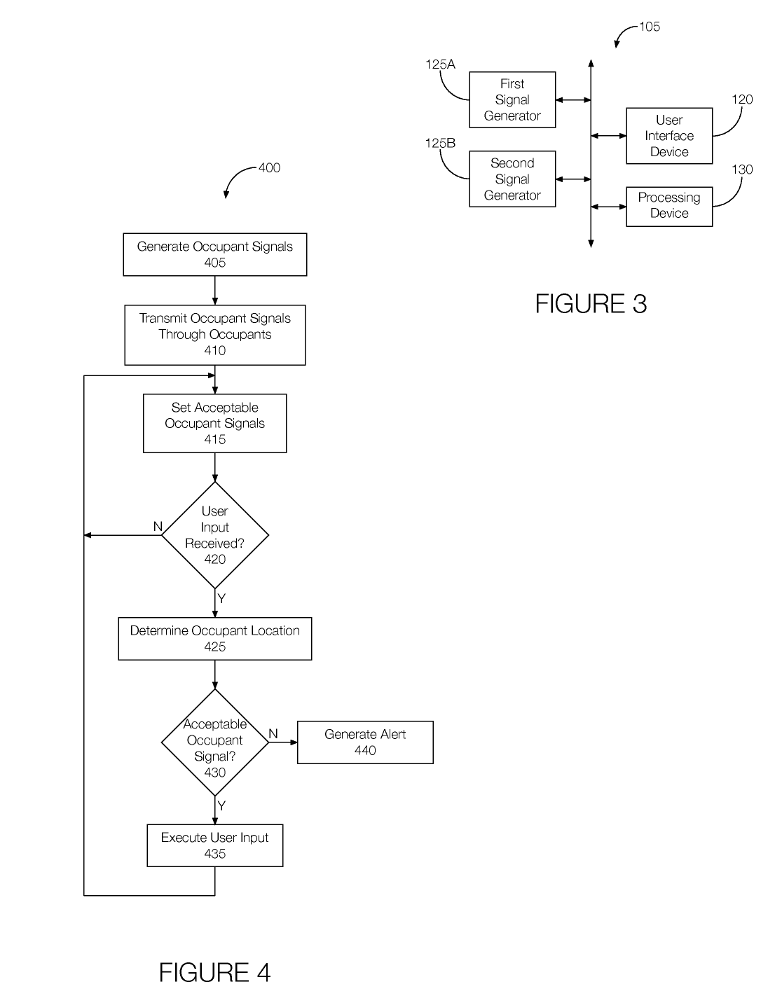

FIGS. 2 and 3 illustrate the identification system 105, with FIG. 2 showing components of the identification system 105 incorporated into the passenger compartment 110. The passenger compartment 110 includes multiple seats 115 and a user interface device 120. The identification system 105 includes at least one signal generator 125 (two are shown in FIGS. 2 and 3) and a processing device 130.

The user interface device 120 may be programmed to present information to an occupant, such as a driver or passenger. The user interface device 120 may be further programmed to receive user inputs. In some possible approaches, the user interface device 120 may include a touch-sensitive display screen programmed to receive occupant signals, as discussed in greater detail below. The user interface device 120 may be programmed to present an alert to one or more occupants. The alert may include an audible alert, a visual alert, a tactile alert, or a combination of different types of alerts. In some possible implementations, the user interface device 120 may be incorporated into a vehicle infotainment system.

The signal generator 125 may include any electronic device configured or programmed to generate an electric signal, referred to below as an occupant signal. The occupant signal may be transmitted at a current with a ultra-low magnitude. For example, the magnitude of the current may be sufficient to travel through part of an occupant but so low that the occupant cannot feel the current or experience any effect. The occupant signal may also be transmitted at a particular frequency or with a particular waveform.

One or more signal generators 125 may be programmed to generate unique occupant signals for each occupant location (i.e., a first occupant signal for a first occupant location, a second occupant signal for a second occupant location, etc.). Each occupant location may refer to a different seat in the passenger compartment 110. For example, the first occupant location may refer to the driver seat and the second occupant location may refer to the front passenger seat. In some possible implementations, one signal generator 125 may output the first occupant signal while a different signal generator 125 outputs the second occupant signal. The signal generators 125 may be electrically connected to one or more occupants either directly or indirectly. That is, the signal generator 125 may transmit the occupant signals through the occupants via, e.g., the seat, seatbelt, steering wheel, a grab handle, etc. When an occupant touches the touch-sensitive display screen, the occupant signal may be passed from the occupant to the user interface device 120.

In some instances, a unique occupant signal may be transmitted through all occupants. In other example approaches, unique occupant signals may only be transmitted through occupants within reach of the user interface device 120. For instance, where the user interface device 120 is near the front of the passenger compartment 110, unique occupant signals may be transmitted through the occupants in the driver seat and front passenger seat. In another possible approach, a single occupant signal may be transmitted through the occupant in the driver seat, the occupant in the passenger seat, but not both. Unique signals may also be assigned to passenger in the second row who may have the ability to reach the front screen 120.

The processing device 130 may include a computing device programmed to receive the occupant signals and identify the location of one or more occupants based on the occupant signals received. The processing device 130 may receive one or more occupant signals from the user interface device 120 and process the received occupant signal. Because the occupant signals are unique in terms of waveform, frequency, current magnitude, etc., the processing device 130 may determine where the user input originated. In other words, the processing device 130 may determine whether the user input was received from an occupant sitting at a first occupant location (e.g., the driver seat) or a second occupant location (e.g., the front passenger seat). In instances where only one occupant signal is transmitted through the driver or the passenger (but not both), the processing device 130 may use the presence or absence of the occupant signal to determine whether the user input originated from the driver or passenger, respectively.

The processing device 130 may be programmed to output command signals based on, e.g., whether an occupant signal has been received and the occupant location associated with the received occupant signal has been determined. The command signals may include a command for the user interface device 120 to ignore (e.g., not execute) a user input or to execute a user input depending on whether the user input was accompanied by a particular occupant signal. In some instances, the command signals may command the user interface device 120 to make certain menu options available or unavailable unless a particular occupant signal is received. Further, the command signals may command the user interface device 120 to generate an alert indicating that certain features of, e.g., the vehicle infotainment system are unavailable to the occupant who provided the user input. In other words, the alert may inform the occupant that the user input was ignored. Examples of alerts may include an audible alert, a visual alert, a tactile alert, or the like.

Accordingly, the identification system 105 may determine whether the driver or passenger initiated a user input, and either accept or reject the user input accordingly. Thus, the identification system 105 may make infotainment features available to the passengers but not the driver, and vice-versa, under certain circumstances.

Although the signal generators 125 are shown as electrically connected to the seats 115 in FIG. 2, one or more of the signal generators 125 may be electrically connected to another component in the passenger compartment 110 of the host vehicle 100. For instance, to provide the first occupant signal to the driver, the first signal generator 125A may alternatively be electrically connected to the steering wheel. To provide the second occupant signal to the passenger, the second signal generator 125B may be alternatively electrically connected to, e.g., a grab handle located in the passenger compartment 110 near, e.g., the front passenger seat.

FIG. 3 is a block diagram of the identification system 105 with multiple signal generators 125. As shown, the identification system 105 includes a first signal generator 125A, a second signal generator 125B, and the processing device 130. The user interface device 120 is also shown in FIG. 3 although the user interface device 120 may be part of a separate system.

The first signal generator 125A is programmed to output the first occupant signal and the second signal generator 125B is programmed to output the second occupant signal. The first occupant signal and second occupant signal may have different waveforms or frequencies. The first occupant signal may be transmitted through a first occupant location (e.g., the driver seat) and the second occupant signal may be transmitted through a second occupant location (e.g., the passenger seat). If the driver (e.g., the person sitting in the driver seat) touches the user interface device 120, the first occupant signal may be transmitted through the driver to the user interface device 120. If the passenger (i.e., the person sitting in the passenger seat) touches the user interface device 120, the second occupant signal may be transmitted through the passenger to the user interface device 120. The processing device 130 may determine who provided the user input based on whether the first occupant signal or the second occupant signal was received via the user interface device 120. Certain operation may be disallowed when both signals are detected simultaneously as this could be the driver controlling the touch screen while the passenger holds the driver's wrist. Full passenger control may only be allowed when only the passenger signal is detected.

In circumstances where user inputs from the driver should be ignored, the processing device 130 may be programmed to command the user interface device 120 to ignore user inputs that accompany the first occupant signal. Moreover, the processing device 130 may command the user interface device 120 to execute user inputs that accompany the second occupant signal. In circumstances where user inputs must come from the driver, the processing device 130 may be programmed to command the user interface device 120 to ignore user inputs that accompany the second occupant signal and execute user inputs that accompany the first occupant signal. In some instances, the user interface device 120 may be programmed to execute or ignore user inputs, without a command from the processing device 130, based on whether the user input is accompanied by the first occupant signal or the second occupant signal. When a user input is ignored, the user interface device 120, on its own or in response to a command from the processing device 130, may be programmed to output the alert indicating that the user input was ignored. The alert may include an audible alert, a visual alert, a tactile alert, etc., and may include an explanation of why the user input was ignored. For example, the alert may include text or a voice explaining that user inputs from the driver are prohibited while the host vehicle 100 is in motion. A tactile alert may indicate to the occupant that the user input was ignored and encourage the occupant to look at the user interface device 120 for more information, including, e.g., an explanation of why the user input was ignored.

FIG. 4 is a flowchart of an example process that may be executed by the identification system 105 for identifying where user inputs originated from within the host vehicle 100. The process 400 may begin when the host vehicle 100 is turned on and may continue to execute until the host vehicle 100 is turned off.

At block 405, the identification system 105 may generate an occupant signal. For instance, the occupant signal may be generated by the signal generator 125, and each signal generator 125 may be configured to output any number of unique occupant signals. If multiple signal generators 125 are available, each signal generator 125 may generate a unique occupant signal. That is, a first signal generator 125 may generate a first occupant signal; a second signal generator 125 may generate a second occupant signal, etc. Each occupant signal may have a unique characteristic such as waveform, frequency, etc.

At block 410, the identification system 105 may transmit the occupant signals through one or more vehicle occupants. The signal generators 125 may be electrically connected to, e.g., the seat, seatbelt, steering wheel, grab handle, etc. The occupant signals may be transmitted through any passenger touching any part of the host vehicle 100 electrically connected to the signal generator 125.

At block 415, the identification system 105 may set acceptable occupant signals. For instance, the processing device 130 may determine whether an occupant signal is acceptable based on various circumstances. Circumstances that require the driver to focus on operating the host vehicle 100 may result in the processing device 130 only setting the occupant signals from the passenger as acceptable. For instance, the processing device 130 may monitor the speed of the host vehicle 100 and determine that only user inputs from the passenger are acceptable if the vehicle speed exceeds a predetermined threshold. Moreover, the acceptable occupant signals may be associated with certain functions. For example, when the host vehicle 100 is travelling above the predetermined threshold, the processing device 130 may set the driver's occupant signal as acceptable for certain functions, such as controlling the radio, climate control, etc., but not others, such as setting a destination in a navigation system.

At decision block 420, the identification system 105 may determine whether a user input has been received. The user input may be received when an occupant touches the user interface device 120. The user interface device 120 may transmit the user input, or at least the occupant signal that accompanies the user input, to the processing device 130. If a user input is received, the process 400 may continue to block 425. If no user input is received, the process 400 may return to block 415.

At block 425, the identification system 105 may determine the location of the occupant who provided the user input based on the occupant signal that accompanies the user input. Since a unique occupant signal is transmitted through one or more occupants based on the location of the occupants, the processing device 130 can determine the location of the passenger who originated the user input based on the occupant signal received.

At decision block 430, the identification system 105 may determine whether the user input was transmitted with an acceptable occupant signal. The processing device 130 may determine whether the occupant signal is acceptable based on whether the receive occupant signal matches the waveform or frequency of one or more occupant signals deemed acceptable at block 415. If an acceptable occupant signal is detected, the process 400 may continue at block 435. If no acceptable occupant signals are received, the process 400 may continue to block 440.

At block 435, the identification system 105 may command the user interface device 120 to execute the user input. For instance, the processing device 130 may output a signal to the user interface device 120 indicating that the user input was received from an acceptable occupant and that the requested feature is available to the occupant who provided the user input. The process 400 may continue at block 415 so that the identification system 105 may consider whether to make other occupant signals acceptable and to await additional user inputs.

At block 440, the identification system 105 may generate an alert. For instance, the processing device 130 may command the user interface device 120 to present an audible or visual alert indicating, e.g., that the user input has been ignored. In some instances, the processing device 130 may command the user interface device 120 to explain why the user input was ignored. An example in response to receiving a user input from the driver may include, e.g., an explanation that the feature is only available to passengers (e.g., not the driver). The process 400 may proceed to block 415 so that the identification system 105 may consider whether to make other occupant signals acceptable and to await additional user inputs.

With the process 400, the identification system 105 can make certain infotainment system features available to some occupants, such as the passengers but not the driver, under certain circumstances. Using the signal generator 125 and a processing device 130 discussed above, the identification system 105 can identify a location of an occupant who provides a user input to the user interface device 120 based an occupant signal transmitted with the user input. The identification system 105, therefore, can determine whether the user input came from the driver or a passenger and command the user interface device 120 to only accept certain user inputs from certain occupants. When the host vehicle 100 is moving above a certain speed, for example, the user interface device 120 may only accept user inputs from passengers and reject user inputs from the driver.

In general, the computing systems and/or devices described may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a signal generator programmed to output an occupant signal; and
a processing device programmed to identify a location of at least one occupant based at least in part on whether a user input provided to a touch-sensitive display device includes the occupant signal.

2. The vehicle system of claim 1, wherein the signal generator includes a first signal generator programmed to output a first occupant signal and a second signal generator programmed to output a second occupant signal.

3. The vehicle system of claim 2, wherein the processing device is programmed to determine whether the occupant is at a first location based at least in part on whether the user input includes the first occupant signal.

4. The vehicle system of claim 3, wherein the processing device is programmed to determine whether the occupant is at a second location based at least in part on whether the user input includes the second occupant signal.

5. The vehicle system of claim 2, wherein the first signal generator is programmed to transmit the first occupant signal through a first occupant at a first location and wherein the second signal generator is programmed to transmit the second occupant signal through a second occupant at a second location.

6. The vehicle system of claim 1, wherein the signal generator is programmed to transmit the occupant signal through at least one occupant.

7. The vehicle system of claim 1, wherein the processing device is programmed to command the user interface to ignore the user input in response to receiving the occupant signal.

8. The vehicle system of claim 1, wherein the processing device is programmed to command the user interface to execute the user input in response to receiving the occupant signal.

9. The vehicle system of claim 1, wherein the user interface device is programmed to ignore user inputs received with a corresponding occupant signal.

10. The vehicle system of claim 8, wherein the user interface device is programmed to generate an alert indicating that the user input was ignored.

11. The vehicle system of claim 1, wherein the location includes at least one of a driver seat and a passenger seat.

12. A method comprising:
generating an occupant signal;
transmitting the occupant signal through a vehicle occupant;
receiving a user input;
determining whether the user input includes the occupant signal; and
identifying a location of the vehicle occupant based at least in part on whether the user input includes the occupant signal.

13. The method of claim 12, wherein generating the occupant signal includes generating a first occupant signal and a second occupant signal.

14. The method of claim 13, wherein identifying the location of the vehicle occupant includes:
identifying the vehicle occupant at a first location if the user input includes the first occupant signal; and
identifying the vehicle occupant at a second location if the user input includes the second occupant signal.

15. The method of claim 13, wherein transmitting the occupant signal includes:
transmitting the first occupant signal through a first occupant at a first location; and
transmitting the second occupant signal through a second occupant at a second location.

16. The method of claim 12, further comprising ignoring the user input in response to receiving the occupant signal.

17. The method of claim 16, further comprising generating an alert indicating that the user input was ignored.

18. The method of claim 12, further comprising executing the user input in response to receiving the occupant signal.

19. The method of claim 12, wherein the location includes at least one of a driver seat and a passenger seat.

20. A vehicle system comprising:
a user interface device having a touch-sensitive display screen programmed to receive a user input;
a first signal generator programmed to transmit a first occupant signal through a first vehicle occupant;
a second signal generator programmed to transmit a second occupant signal through second vehicle occupant; and
a processing device programmed to identify a location of the first occupant and the second occupant in a passenger compartment of a vehicle based at least in part on whether the user input includes the first occupant signal or the second occupant signal.
